(19) United States
(12) Patent Application Publication
(10) Pub. No.: US 2006/0285449 A1
(43) Pub. Date: Dec. 21, 2006

(54) Optical disk drive and method of controlling the same

(76) Inventor: Yoshinori Tazaki, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/205,080

(22) Filed: Aug. 17, 2005

(30) Foreign Application Priority Data
Jun. 20, 2005 (JP) 2005-179301

(51) Int. Cl. G11B 7/00; G11B 15/04

(52) U.S. Cl. 369/44.26; 369/53.24

(57) ABSTRACT

An area unused for recording the information is detected in an information recording layer that is the layer jump destination of an optical disk having a plurality of information recording layers. In the current information recording layer, a laser beam is temporarily moved to a position corresponding to the area unused for information recording, and thereafter, a layer jump operation is carried out.

### CROSS-REFERENCE TO RELATED APPLICATIONS

This application is based upon and claims the benefit of priority from prior Japanese Patent Application No. 2005-179301, filed Jun. 20, 2005, the entire contents of which are incorporated herein by reference.

### BACKGROUND OF THE INVENTION

1. Field of the Invention

The present invention relates to an optical disk drive, which reproduces (reads) and records information with respect to an optical disk having a plurality of information recording layers. In particular, the present invention relates to an optical disk drive, which performs layer jump for moving a laser beam focused position between information recording layers to record or reproduce information from one information recording layer to another layer. Moreover, the present invention relates to a method of controlling the optical disk drive.

2. Description of the Related Art

A multilayer recording optical disk has been standardized; for this reason, layer jump to unrecorded areas is required. In the multilayer recording optical disk, jumping to the upper layer is conventionally executed after writing to the bottom most layer (i.e., recording layer nearest to the surface of the optical disk) is completed. In this case, runout and acceleration considerably increase in the outer circumference of the optical disk. For this reason, the following technique (e.g., JPN. PAT. APPLN. KOKAI Publication No. 2000-207750) is disclosed considering a high possibility that layer jump fails. According to the technique, the runout is reduced, and further, the laser beam is moved to the inner circumferential position of the optical disk to readily give the layer jump.

However, the foregoing conventional technique has the following problem. Even if the layer jump is made in the inner circumferential position of the optical disk, focusing servo is out of control resulting from the fail. As a result, there is a possibility that an objective lens of a pickup scratches the surface of the optical disk because of contacting with the optical disk. In reproducing the scratched optical disk, correction is possible if data before and after the scratched portion is correctly readable. However, in recording, a write error is produced if address of the recording portion is not read. If the write error is produced, the optical disk is not available; as a result, there is a possibility that already recorded data is not read from the optical disk. Thus, if the foregoing trouble occurs after recording sensitive information to the multilayer recording optical disk, the extremely serious problem is given to user. Specifically, user, who records information to the optical disk loses his important property.

### BRIEF SUMMARY OF THE INVENTION

An object of the present invention is to provide an optical disk drive, which controls a jump position when layer jump is made in a multilayer recording optical disk to prevent generation of a write error and to protect the optical disk recording information if the layer jump fails. Another object of the present invention is to provide a method of controlling the optical disk drive.

In order to solve the foregoing problem, according to one aspect of the present invention, there is provided an optical disk drive, which emits a laser beam to an information recording layer of an optical disk having a plurality of information recording layers to record or reproduce (read) information, comprising:

pickup means arranged facing a surface of the optical disk, and having an objective lens focusing the laser beam onto the information recording layer;

objective lens moving means for moving the objective lens to a direction vertical to the information recording layer of the optical disk, and setting a focusing position of the laser beam with respect to the information recording layer;

layer jump means for moving the focusing position of the laser beam from a first information recording layer to a second information recording layer between said a plurality of information recording layers using the objective lens moving means;

detection means for detecting an information recording non-use area in a destination of focusing position of the laser beam by the layer jump means, that is, the second information recording layer; and

layer jump control means for moving the laser beam to an area of the first information recording layer corresponding to the information recording non-use area of the second information recording layer before the layer jump means moves the focusing position between layers, and carrying out a move of the focused position between layers by the layer jump means after the laser beam is moved to the area of the first information recording layer.

Therefore, in the optical disk drive of the present invention, the layer jump is made on the position different from an area recording information. By doing so, even if the layer jump fails, the damage is reduced.

According to the present invention, the jump position is controlled when giving the layer jump in the multilayer recording optical disk. By doing so, even if the layer jump fails, there is provided an optical disk drive, which can prevent generation of a write error and protect the optical disk recording information, and information processing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing a notebook type personal computer according to one embodiment of the present invention;

FIG. 2 is a schematic view showing an optical (disk) drive according to one embodiment of the present invention;

FIG. 3 is a schematic view showing a drawer ejected from the optical (disk) drive according to one embodiment of the present invention;

FIG. 4 is a block diagram showing the configuration of the optical disk drive according to one embodiment of the present invention;

FIG. 5 is a schematic view showing the cross section of an optical disk to explain the method of controlling the optical disk drive according to one embodiment of the present invention;

FIG. 6 is a schematic view showing the cross section of an optical disk to explain the method of controlling the optical disk drive according to one embodiment of the present invention; and

FIG. 7 is a flowchart to explain the method of controlling the optical disk drive according to one embodiment of the present invention.

### DETAILED DESCRIPTION OF THE INVENTION

One embodiment of the present invention will be described below with reference to the accompanying drawings.

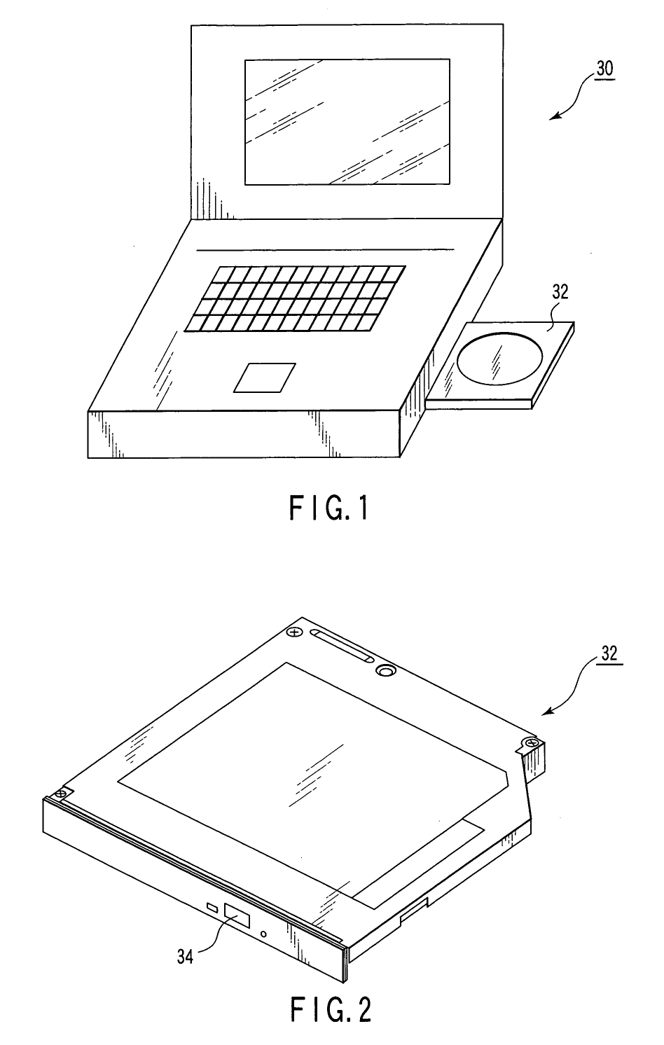

FIG. 1 is a schematic view showing a notebook-type personal computer 30. The personal computer 30 is loaded with an optical disk drive of the present invention; for example, a slim-type optical disk drive 32 having a built-in DVD drive. (FIG. 1 shows a state that a tray of the optical disk drive is ejected.) The personal computer 30 includes semiconductor memory, hard disk drive and CPU with respect to the optical disk drive 32. The foregoing semiconductor memory and hard disk drive store information recorded on an optical disk and information reproduced (read) therefrom. The CPU gives instructions to record and reproduce information to the optical disk, and makes information processing.

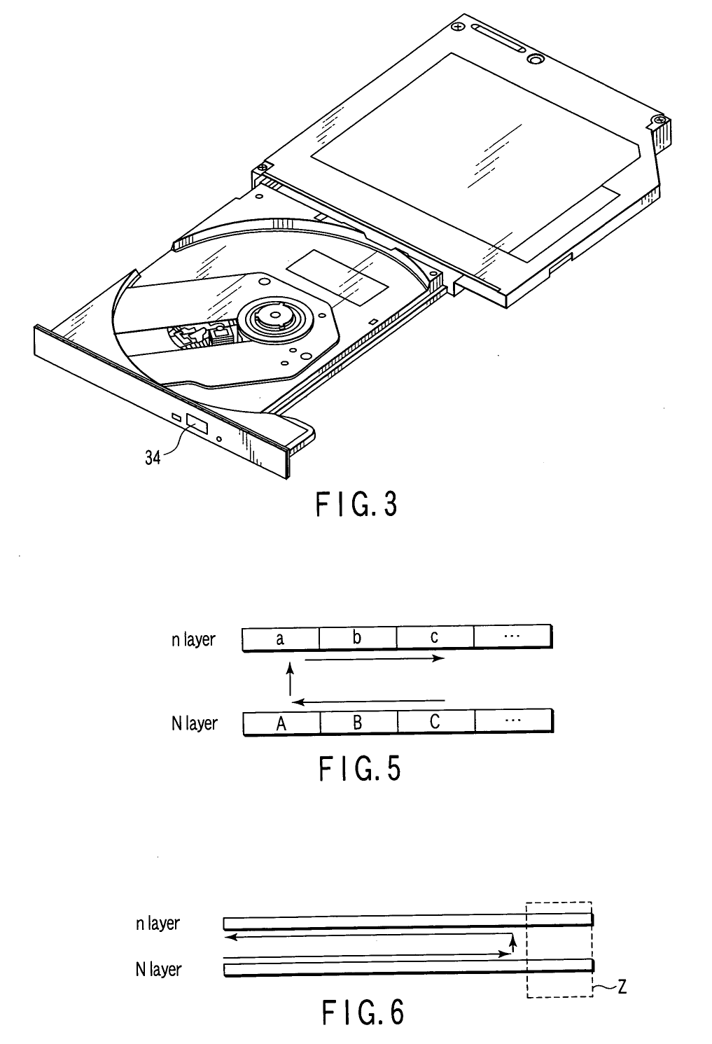

The optical disk drive 32 includes an eject button 34 as illustrated in FIG. 2. User presses the eject button 34, and thereby, a drawer is ejected therefrom as seen from FIG. 3.

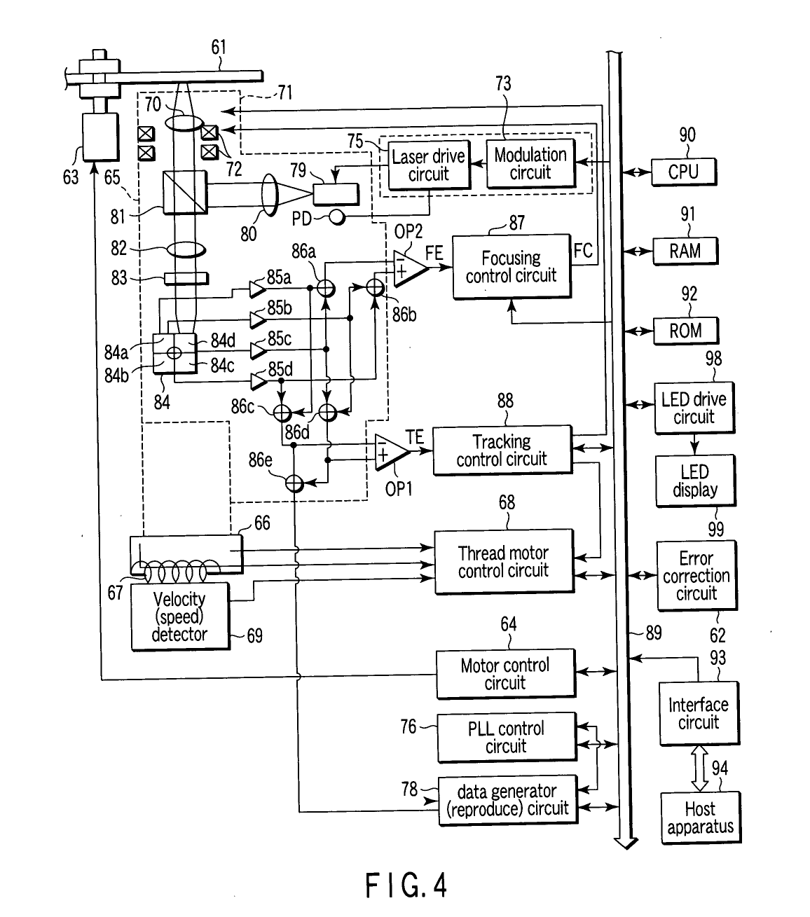

FIG. 4 is a block diagram showing the configuration of the optical disk drive according to the present invention.

In FIG. 4, an optical disk 61 is a user data recordable or read-only optical disk. In this embodiment, the explanation will be made giving a recordable multilayer optical disk as an example. Incidentally, DVD-R and the like are given as an optical disk having a plurality of information recording layers. The present invention is not limited to the DVD-R; in this case, any other forms may be used so long as it is a multilayer recordable optical disk.

An information recoding layer of the optical disk 61 is formed with spiral land track and groove track. The optical disk 61 is rotatably driven by a spindle motor 63.

Information recording and reproducing (reading) with respect to the optical disk 61 are carried out using an optical pickup 65 (surrounded by the broken line in FIG. 4). The optical pickup 65 is connected with a thread motor 66 via a gear. The thread motor 66 is controlled via a thread motor control circuit 68. A velocity (speed) detection circuit 69 detects a moving velocity of the optical pickup, and is connected to the thread motor control circuit 68. A velocity signal of the optical pickup 65 detected by the velocity detection circuit 69 is supplied to the thread motor control circuit 68. A stator of the thread motor 66 is attached with a permanent magnet (not shown). A drive coil 67 is excited via the thread motor control circuit 68, and thereby, the pickup 65 is driven in the radial direction of the optical disk 61.

The optical pickup 65 is provided with an objective lens 70, which is supported by a wire or flat spring (not shown). The objective lens 70 is movable to the focusing direction (optical axis direction of lens) by the drive of a drive coil 72. Moreover, the objective lens 70 is movable to the tracking direction (perpendicular to the optical axis of lens) by the drive of a drive coil 71.

A modulator circuit 73 receives a recording information signal from a host apparatus 94 via interface circuit 93 and bus 89 in recording information on the optical disk 61. Then, the modulator circuit 73 modulates the received signal according to a modulation method (e.g., 8-16 modulation (code)) conformable to the standards of the optical disk 61. A laser drive circuit 75 supplies a write signal to a semiconductor laser diode 79 based on modulation data supplied from the modulator circuit 73 in information recording to the optical disk 61 (mark forming). In reproducing information, the laser drive circuit 75 supplies a read signal smaller than the write signal to the semiconductor laser diode 79.

The semiconductor laser diode 79 generates a laser beam in accordance with a signal supplied from the laser drive circuit 75. The laser beam emitted from the semiconductor laser diode 79 is applied onto the optical disk 61 via collimator lens 80, half prism 81 and objective lens 70. The reflected light from optical disk 61 is guided to a photodetector 84 via objective lens 70, collective lens 82 and cylindrical lens 83.

The photodetector 84 is composed of divided four photo detection cells 84a to 84d. Output signals of photo detection cells 84a to 84d of the photodetector 84 are supplied to adders 86a to 86d via current/voltage conversion amplifiers 85a to 85d, respectively. In this case, the adder 86a adds outputs from photodetection cells 84a and 84c, and the adder 86b adds outputs from photodetection cells 84b and 84d. The adder 86c adds outputs from photodetection cells 84a and 84d, and the adder 86d adds outputs from photodetection cells 84b and 84c. The outputs of the adders 86a and 86b are supplied to a differential amplifier OP2. On the other hand, the outputs of the adders 86c and 86d are supplied to a differential amplifier OP1.

The differential amplifier OP2 generates a focus error signal FE corresponding to the difference of both output signals of adders 86a and 86b. The focus error signal FE is supplied to a focusing control circuit 87. An output signal of the focusing control circuit 87 is supplied to the focusing drive coil 72. In this way, control is carried out so that the laser beam is always focused onto the recording layer of the optical disk 61.

The differential amplifier OP1 generates a tracking error signal TE corresponding to the difference of both output signals of adders 86c and 86d. The tracking error signal TE is supplied to a tracking control circuit 88. The tracking control circuit 88 generates a tracking drive signal in accordance with the tracking error signal TE.

The tracking drive signal outputted from the tracking control circuit 88 is supplied to the drive coil 71 for driving the objective lens 70 to eh direction perpendicular to the optical axis. The tracking error signal used for the tracking control circuit 88 is supplied to the thread motor control circuit 68.

Focusing and tracking controls are carried out in the manner described above. Thus, a signal faithful to recording information is obtained according to a summing signal of output signals of photodetection cells 84a to 84d of the photodetector 84, that is, output summing signal RF of an adder 86e adding both output signals of adders 86c and 86d. The signal is supplied to a data generator (reproduction) circuit 78.

The data generator circuit 78 reproduces recording data based on a regenerative clock signal from a PLL circuit 76. The data generator circuit 78 further has a function of measuring the amplitude of the signal RF, and the measured value is outputted to the CPU 90.

When the tracking control circuit 88 controls the objective lens 70, the thread motor control circuit 68 controls the thread motor 66 to move the optical pickup 65 so that the objective lens 70 is positioned near the center position in the optical pickup 65.

The following circuits may be integrated on one LSI chip. The circuits are motor control circuit 64, thread motor control circuit 68, modulator circuit 73, laser control circuit 75, PLL circuit 76, data generator circuit 78, focusing control circuit 87 and tracking control circuit 88. The CPU 90 controls the foregoing circuits via the bus 89. The CPU 90 collectively controls recording/reproducing of the optical disk drive according to operation commands supplied from the host apparatus 94 via the interface circuit 93. Moreover, the CPU 90 uses a RAM 91 as a work area, and carries out predetermined control according to a program including procedures relevant to this invention, recorded in ROM 92.

The method of controlling the optical disk drive to which the present invention is applied will be described below with reference to FIG. 5 to FIG. 7. The method of controlling the optical disk drive of the present invention has the following features. Specifically, when layer jump is made in the multilayer optical disk, it is made with respect to an area where information recording is not made in the jump-destination recording layer.

<Case Where Area Unused for Recording Physically Exists on Optical Disk>

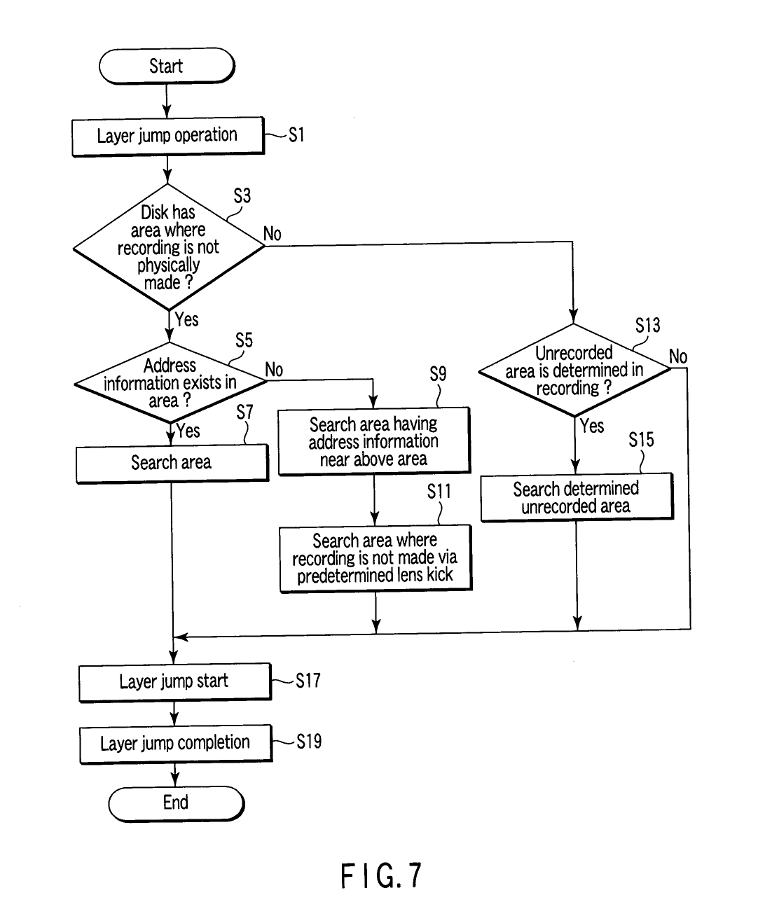

When layer jump is made from one recording layer to another recording layer, the following case is given. Specifically, an area, which is not used for information recording, exists in the jump-destination recording layer, as a matter of the optical disk standard or structure. For example, an information recording non-use (blank) area is defined as the physical standard of the optical disk. In this case, if the host apparatus 94 issues a layer jump instruction (step S1 of FIG. 7), the CPU 90 determines whether or not a blank area exists. If “Yes” is given in step S3 of FIG. 7, the CPU 90 controls thread motor control circuit 68 and tracking control circuit 88 so that they make a search operation. The foregoing control circuits search an area “A” of the jump-beginning recording layer (currently focused by the pickup 65) (N-layer) corresponding to an area “a” of a blank area of the jump-destination recording layer (n-layer), as shown in FIG. 5. Then, the laser beam of the pickup 65 is moved from the current position, that is, area “C” of the N-layer to the area “A”. Usually, the area “A” is also a blank area. (n and N are integers.)

The foregoing search is completed, and thereafter, layer jump is made from the area “A” of the N-layer to the area “a” of the n-layer (step S17 of FIG. 7). The layer jump is achieved in a manner of controlling the focusing control circuit 87 to drive the objective lens 70 vertically to disk surface. The layer jump is made, and thereafter, when being focused on the area “a” of the n-layer, the laser beam is moved to an area “c”. This is achieved via the search operation like move from the area “C” to the area “A” in the N-layer. Move to the area “c” is completed, and thereafter, the laser beam is returned to the disk radius position situated when layer jump instruction is issued. In this way, the laser beam becomes a state of being transferred from the N-layer to the n-layer. Thus, the layer jump is completed (step S19 of FIG. 7).

The foregoing search operation will be described below.

If address information exits in a wobbled (pit) on the track of the optical disk, search is made according to lens-kick based on the address information. Whether or not address information exits in the wobble is determined in the following manner. For example, when the optical disk drive is loaded with an optical disk, it is previously determined from a wobble in a recording layer nearest to the disk surface.

Address information exists in the area “A” of the N-layer corresponding to the blank area of the n-layer, that is, area “a” (“Yes” in step S5 of FIG. 7). In this case, predetermined address of the area “A” is searched based on the foregoing address information (step S7 of FIG. 7).

If address information does not exist in the area “A”, an area (e.g., area “B”) necessarily having address is temporarily searched (step S9 of FIG. 7). Lens-kick having a move distance of a predetermined number of tracks is made several times (step S11 of FIG. 7).

If address information does not exist in the wobble, an optical disk including a blank area (area “A”) having previously specified address is used. According to a fixed cont-kick (kont-kick), the area “A” is searched from the fixed position of optical pickup (e.g., innermost circumferential position). In this way, the relationship between the number of contkicks and the address is learned. If an optical disk having no address information is loaded, laser beam is guided to the blank area of the disk using the leaned content.

<Case Where Area Unused for Recording is Determined when Recording Instruction is Issued>

If physical standard area unused for recording does not exist in the optical disk as described above, layer jump control will be described. In particular, the case where an area unused for recording is determined via a command from recording application will be described below with reference to FIG. 6. In this case, an area unused for recording is determined based on the command from the recording application, and then, layer jump is made using the area.

If recording is made with respect to an optical disk using Disc at once, application side determines a turn-back position on the outer circumference in the radius direction of the optical disk. In this case, the turn-back position is estimated to be set to the inner circumference a much as possible to shorten recording time to the optical disk. This results from the following reason. Specifically, at first, recording is made up to the outermost circumference of the N-layer, and thereafter, continued from the outermost circumference of the n-layer. In this case, remaining areas exists in the inner circumference of the n-layer; for this reason, the area must be recorded using dummy data. As a result, unnecessary recording time is spent.

As seen from the broken line shown in FIG. 6, there is high possibility that an area (unused area) Z unused for recording exists outside from the information recording outermost position of n- and N-layers. Thus, in the case of using foregoing disc at once, the non-used area Z is already specified in the recording start (“Yes” in step S13 of FIG. 7). Therefore, recording is made up to the information recording outermost position, and thereafter, the non-used area Z is further searched in the outer circumferential side (step S15 of FIG. 7). Then, layer jump is made in the foregoing area. The search operation of the non-use area Z is possible using conventional lens-kick because address information exists in the wobble.

Layer jump is made, and thereafter, lens-kick is carried out toward the inner circumference from the layer jump position (layer jump is completed), and then, the recording operation restarts.

In also case of using a write-once read multiple mode in place of the disc at once, if an area unused for recording is specified, layer jump is made using the area like the foregoing manner.

Moreover, already recorded area may be used as the area unused for recording to make layer jump. In this case, even if layer jump fails and damage is given to the optical disk, reproduction is possible via error correction so long as it the damaged area is an area used for read only. Therefore, it is possible to prevent the situation that the optical disk is not available.

According to the present invention, the jump position is controlled when layer jump is made in a multilayer recording optical disk. In this way, it is possible to prevent a generation of write error, and to protect the optical disk recording information even if the layer jump fails.

The present invention is not limited to the foregoing embodiment. In this case, constituent components are modified within the scope without diverging from the subject matter of the invention in the working step. Several constituent components disclosed in the foregoing embodiment are properly combined, and thereby, various inventions may be formed. For example, some components may be deleted from the whole constituent components disclosed in the embodiment. Moreover, constituent components disclosed in different embodiment may be properly combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk drive, which emits a laser beam to an information recording layer of an optical disk having a plurality of information recording layers to record or reproduce (read) information, comprising:
pickup means arranged facing a surface of the optical disk, and having an objective lens focusing the laser beam onto the information recording layer;
objective lens moving means for moving the objective lens to a direction vertical to the information recording layer of the optical disk, and setting a focusing position of the laser beam with respect to the information recording layer;
layer jump means for moving the focusing position of the laser beam from a first information recording layer to a second information recording layer between said a plurality of information recording layers using the objective lens moving means;
detection means for detecting an information recording non-use area in a destination of focusing position of the laser beam by the layer jump means, that is, the second information recording layer; and
layer jump control means for moving the laser beam to an area of the first information recording layer corresponding to the information recording non-use area of the second information recording layer before the layer jump means moves the focusing position between layers, and carrying out a move of the focusing position between layers by the layer jump means after the laser beam is moved to the area of he first information recording layer.

2. The drive according to claim 1, wherein the detection means detects an area defined as an area unused for recording on the standards of the optical disk in the second information recording layer, or areas other than an area specified as a recording area before a recording operation, as the information recording non-use area.

3. An optical disk drive, which emits a laser beam to an information recording layer of an optical disk having a plurality of information recording layers to record or reproduce (read) information, comprising;
pickup means arranged facing a surface of the optical disk, and having an objective lens focusing the laser beam onto the information recording layer;
objective lens moving means for moving the objective lens to a direction vertical to the information recording layer of the optical disk, and setting a focusing position of the laser beam with respect to the information recording layer;
layer jump means for moving the focusing position of the laser beam from a first information recording layer to a second information recording layer between said a plurality of information recording layers using the objective lens moving means;
detection means for detecting an information recording non-use area in a destination of focusing position of the laser beam by the layer jump means, that is, the second information recording layer; and
layer jump control means for moving the laser beam to an area of the first information recording layer corresponding to an area outside from the information recording outermost circumferential position of the second information recording layer before the layer jump means moves the focusing position between layers, and carrying out a move of the focusing position between layers by the layer jump means after the laser beam is moved the area of the first information recording layer.

4. A method of controlling an optical disk drive, which emits a laser beam to an information recording layer of an optical disk having a plurality of information recording layers to record or reproduce (read) information, and includes: pickup means arranged facing a surface of the optical disk, and having an objective lens focusing the laser beam onto the information recording layer; objective lens moving means for moving the objective lens to a direction vertical to the information recording layer of the optical disk, and setting a focusing position of the laser beam with respect to the information recording layer; and layer jump means for moving the focusing position of the laser beam from a first information recording layer to a second information recording layer between said a plurality of information recording layers using the objective lens moving means, comprising:
a detection step of detecting an information recording non-use area in a destination of focusing position of the laser beam by the layer jump means, that is, the second information recording layer;
a layer jump control step of moving the laser beam to an area of the first information recording layer corresponding to an information recording non-use area of the second information recording layer, and carrying out a move of the focusing position between layers by the layer jump means after the laser beam is moved to the area of the first information recording layer.

5. The method according to claim 4, wherein the detection means detects an area defined as an area unused for recording on the standards of the optical disk in the second information recording layer, or an area outside from the information recording outermost circumferential position of the second information recording layer, as the information recording non-use area.
